(19) United States
(12) Patent Application Publication
(10) Pub. No.: US 2005/0131810 A1
(43) Pub. Date: Jun. 16, 2005

(54) Methods and systems for payment of equipment usage

(76) Inventor: Sandy Garrett, San Francisco, CA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/734,046

(22) Filed: Dec. 11, 2003

(51) Int. Cl. G06F 17/60

(52) U.S. Cl. 705/39; 705/40

(57) ABSTRACT

Disclosed are methods and systems for converting the fixed cost of capital to a variable expense including structuring an operating lease based on a “unit of manufacturing” depreciation schedule rather than a time based depreciation, allowing charges to the customer on a “per unit” (per test hour, per component, per process, etc.) basis and aligning expenses to production. The customer can commit to a total usage of the equipment and a minimum usage of the equipment per a specified time period; however, the minimum commitment can be a “cumulative” commitment, rather than based on each period, that can allow for a “pay-per-use” program. The customer can make payments for the actual usage of the equipment during a current time period, provided that the aggregated usage credited to the user from the commencement of the lease is at least equal to the cumulative commitment.

### BACKGROUND

(1) Field

The disclosed methods and systems relate to equipment leasing, and more particularly to structuring equipment usage agreements.

(2) Description of Relevant Art

In many industries, the cost of fixed capital equipment ownership is high relative to revenue and, in some cases can even exceed 20%. Such high costs of ownership can be onerous to equipment users, particularly in cyclical economic and technological environments. Compounding this situation, many of these same industries experience periods of rapid growth followed by severe downturns in the industry due to the economy and/or overcapacity. In some industries, the rise of third party testing, process applications, and production and the accelerating movement to outsourcing are manifestations of the increasing magnitude and frequency of the above cyclical behavior and the escalating fixed cost of capital equipment. Similarly, the increasing interest in leasing and third party financing further evidences this growing pressure.

The problems arising from shortening technology roadmaps, end-user product cycles, component device life cycles, and production equipment cycles are being compounded by industries' greater sensitivity to global economic cycles. In some instances, financial factors can overpower technical considerations. This can lead to conflict between suppliers of equipment and their customers as each looks to the other to absorb unacceptable business risks associated with capital equipment acquisition.

Traditionally, customers frequently sought to lease equipment from suppliers to help reduce the risk of capital equipment ownership or to transfer tax benefits. Such leases have been configured with fixed expense recognition for reporting purposes, even if payments were sometimes variable, due to Generally Accepted Accounting Principals (GAAP) and the guidelines of the Financial Accounting Standards Board Statement No. 13, “Accounting for Leases” (FASB 13). Further, traditional leases are generally configured such that lease payments and/or expense recognition begin when the equipment is first delivered to the customer. Many high-tech industries require considerable time for prototyping prior to beginning actual production, yet, traditional leases do not reflect the non-production use of the equipment and the users can experience significant depreciation prior to putting the equipment into production and deriving revenue. During cyclical downturns, with pressure to reduce expenses, companies with high fixed capital costs frequently reduce headcounts first and, if the downturn is severe enough, worthwhile research and development programs may be cut that might otherwise lead to future growth and hiring.

### SUMMARY

Disclosed are methods and systems for converting a fixed cost of capital to a variable expense. The methods and systems can include structuring an operating lease based on a “unit of manufacturing” depreciation schedule rather than a time based depreciation, allowing charges to the customer on a “per unit” (per test hour, per component, per process, etc.) basis and aligning expenses to production. The customer can commit to a minimum usage of the equipment per a specified time period; however, the commitment can be a “cumulative” commitment rather than based on each period, where the cumulative commitment can allow for a “pay-per-use” program. In some embodiments, the customer can make payments for the actual usage of the equipment during a time period, provided that the aggregated usage credited to the user is equal to or greater than the cumulative commitment.

In one embodiment, methods and systems for payment of equipment usage can include establishing a minimum commitment for equipment usage per time period, and exchanging payments for the equipment usage per time period based on a greater one of aggregated usage and cumulative minimum commitments. Exchanging payments can include multiplying the equipment usage by a price per unit of usage to obtain a usage payment, determining a first difference between the cumulative minimum commitment and the aggregated usage when the aggregated usage is less than the cumulative minimum commitment, adding to the usage payment an amount determined by multiplying the first difference by the price per unit of usage, and updating the aggregated usage to include the first difference. Exchanging payments can include determining a second difference between the aggregated usage and a cumulative usage when the aggregated usage is at least equal to the cumulative minimum commitment and the cumulative usage is less than the aggregated usage, subtracting from the usage payment an amount determined by multiplying a lesser one of the first difference and the second difference by the price per unit of usage, and updating the aggregated usage by subtracting the lesser one of the first difference and the second difference.

Establishing the minimum commitment can include identifying costs for the equipment and identifying the price per unit of usage based on the costs of the equipment. The costs can be based on, but not limited to, an acquisition cost of the equipment, services to be provided with the equipment, and/or supplies to be provided with the equipment. The costs can also be based on, but not limited to, an expected value of the equipment after a predetermined number of time periods, remarketing costs, a time value of money, profit margins, and/or risk of loss.

The methods and systems can include identifying a number of time periods as a term for the usage of the equipment and identifying a total commitment for the term as a sum of the minimum commitments for the time periods of the term, wherein the exchange of payments can be limited by the total commitment. The methods and systems can include exchanging a payment to purchase the equipment when the cumulative usage exceeds the total commitment and/or the total of payments exceeds the total commitment multiplied by the price per unit of usage.

The methods and systems can include determining a price per unit of usage based on continued usage of the equipment beyond the total commitment, increasing the total commitment when the aggregated usage exceeds the total commitment, and exchanging payments for continued usage based on the continued usage multiplied by the price per unit of usage.

The methods and systems can include setting the minimum commitment for at least one time period at a start of the equipment usage to a lesser amount than the minimum commitment for other time periods. The methods and systems can include increasing the minimum commitment to obtain upgrades for the equipment. Also disclosed is remarketing the equipment to obtain new equipment and changing the minimum commitment based on a difference between a market value and a value realized by the remarketing. A payment can be exchanged based on the difference. The equipment can include multiple pieces of equipment, and the methods and systems can include combining the usage of the multiple pieces of equipment to obtain the equipment usage per time period.

In one embodiment, a method of payment for equipment usage can include establishing a minimum commitment for equipment usage per time period based on multiplying a minimum number of units of usage per time period by a price per unit of usage, multiplying an aggregated usage by the price per unit of usage to obtain a first payment, exchanging payments for the equipment usage per time period based on subtracting a total of previous payments from the greater one of the first payment or the cumulative minimum commitments, and updating the aggregated usage to reflect the cumulative minimum commitments when the cumulative minimum commitments exceed the first payment. Exchanging payments can include determining a first difference based on subtracting the cumulative minimum commitments from the first payment when the first payment is greater than the cumulative minimum commitments, determining a second difference based on multiplying a result of subtracting cumulative usage from the aggregated usage by the price per unit of usage when the cumulative usage is less than the aggregated usage, subtracting from the first payment an amount equal to multiplying a lesser one of the first difference and the second difference by the price per unit of usage, and updating the aggregated usage by subtracting the lesser one of the first difference and the second difference from the aggregated usage.

In one embodiment, disclosed is a computer program tangibly stored on a computer-readable medium and operable to cause a computer to enable structuring a requirements contract for equipment usage. The computer program can include instructions to establish a price per unit of usage, establish a minimum number of units of usage per time period, track usage of the equipment per time period, obtain payments per time period based on multiplying a credited number of units of usage by a price per unit of usage and subtracting a total of previous payments, wherein cumulative payments for a number of time periods are at least equal to an amount determined by multiplying a total of the minimum number of units of usage over the number of time periods by the price per unit of usage, and to update the credited usage to reflect the cumulative payments when the total of the minimum number of units of usage over the number of time periods exceeds the credited usage.

The computer program can further include instructions to subtract a credit from the payments for the equipment usage for a time period when the credited usage is greater than the total of the minimum number of units through the time period, and greater than the cumulative usage through the time period, and instructions to update the credited usage to reflect the credit. The instructions to subtract the credit can include instructions to determine a first difference between the credited usage and the cumulative usage, determine a second difference between the credited usage and the total of the minimum number of units, and determine the credit by multiplying the price per unit of usage by a lesser one of the first difference and the second difference.

The instructions to establish a price per unit of usage can include instructions to establish the price per unit of usage based on, but not limited to, an acquisition cost of the equipment, services to be provided with the equipment, and/or supplies to be provided with the equipment. The instructions to establish a price per unit of usage can include instructions to establish the value of the equipment based on, but not limited to, expected remarketing costs, a time value of money, profit margins, and/or risk of loss.

The computer program can include instructions to identify a number of time periods as a term for the usage of the equipment, identify a total commitment for the term of usage as the sum of the minimum number of units of usage for the time periods of the term, and limit the payments obtained to the total commitment multiplied by the price per unit of usage. The computer program can include instructions to obtain a payment to purchase the equipment when the total of payments exceeds the total commitment multiplied by the price per unit of usage. The computer program can include instructions to determine a price per unit of usage based on continued usage of the equipment beyond the total commitment and obtain payments for continued usage based on the continued usage multiplied by the price per unit of usage.

The computer program can include instructions to set the minimum number of units of usage for at least one time period at a start of the equipment usage to a lesser amount than the minimum number of units of usage for other time periods. The computer program can include instructions to increase the minimum number of units of usage and obtain upgrades for the equipment based on the increase. The computer program can include instructions to remarket the equipment to obtain new equipment and adjust the payments based on a difference between a market value and a value realized by the remarket. When the equipment includes multiple pieces of equipment, the instructions to track usage can include instructions to combine usage for the multiple pieces of equipment.

In one embodiment, a method of leasing equipment can include establishing a price per unit of equipment usage, establishing a minimum number of units of equipment usage per time period, exchanging payments per time period based on multiplying a credited number of units of usage by the price per unit of equipment usage and subtracting a total of previous payments, wherein cumulative payments for a number of time periods are at least equal to an amount determined by multiplying a total of the minimum number of units of equipment usage over the number of time periods by the price per unit of equipment usage, and updating the credited usage to reflect the cumulative payments when the total of the minimum number of units of equipment usage over the number of time periods exceeds the credited usage.

In one embodiment, a method of leasing equipment for a specified number of time periods can include providing the equipment for use, identifying a value of the equipment, identifying a price per unit of usage based on the value of the equipment, establishing a cumulative minimum number of units of usage per each of the time periods, tracking usage of the equipment for each time period and adding the usage to previous usage to obtain total usage, obtaining payments for the usage of the equipment per time period based on multiplying the greater one of the total usage and the cumulative minimum number by a price per unit of usage and subtracting a total of previous payments, and updating the total usage to reflect the cumulative minimum number when the cumulative minimum number is greater than the total usage.

In one embodiment, a method of depreciating equipment can include establishing a minimum commitment for usage of the equipment per time period, establishing a price per unit of usage, determining a greater one of the cumulative usage and the cumulative minimum commitment for a time period, multiplying the greater one by the price per unit of usage and subtracting a total of the previous depreciation to obtain a depreciation expense for the time period, incurring the depreciation expense, and updating the cumulative usage to reflect the cumulative minimum commitment when the cumulative minimum commitment is greater than the cumulative usage.

In one embodiment, there is disclosed a computer program tangibly stored on a computer-readable medium and operable to cause a computer to enable depreciation of equipment. The computer program can include instructions to establish a minimum commitment for usage of the equipment per time period, establish a price per unit of usage, determine a greater one of a credited usage and the cumulative minimum commitment for a time period, multiply the greater one by the price per unit of usage and subtract a total of the previous depreciation to obtain a depreciation expense for the time period, incur the depreciation expense, and update the credited usage to reflect the cumulative minimum commitment when the cumulative minimum commitment is greater than the credited usage. The instructions to establish a price per unit of usage can include instructions to adjust the price per unit of usage when a predetermined threshold amount of usage is exceeded.

The instructions to establish a price per unit of usage can include instructions to identify costs of the equipment and determine the price per unit of usage based on the costs of the equipment. The instructions to identify costs of the equipment can include instructions to determine the costs based on, but not limited to, an acquisition cost of the equipment, services to be provided, and/or supplies to be provided. The instructions to identify costs of the equipment can include instructions to determine costs based on, but not limited to, expected remarketing costs, a time value of money, profit margins, and/or risk of loss. The computer program can include instructions to identify a number of time periods as a term for the usage of the equipment and to limit the depreciation expense to a sum of the minimum commitments for the time periods of the term multiplied by the price per unit of usage. The computer program can include instructions to purchase the equipment when the credited usage exceeds the sum of the minimum commitments. The computer program can include instructions to determine a price per unit of usage based on continued usage of the equipment beyond the sum of the minimum commitments and to incur additional depreciation expense for the continued usage based on the continued usage multiplied by the price per unit of usage.

The computer program can include instructions to set the minimum commitment for at least one time period at a start of the equipment usage to a lesser amount than the minimum commitment for other time periods. The computer program can include instructions to increase the minimum number of units of usage and obtain upgrades for the equipment based on the increase. The computer program can include instructions to remarket the equipment to obtain new equipment and adjust the depreciation expense based on a difference between a market value and a value realized by the remarket. The instructions to incur the depreciation expense can include instructions to subtract a credit from the depreciation expense for a time period when the credited usage is greater than the total of the minimum number of units through the time period, and greater than cumulative usage through the time period, and to update the credited usage to reflect the credit. When the equipment comprises multiple pieces of equipment, the computer program can include instructions to track usage per time period for each one of the multiple pieces of equipment and combine the usages for the multiple pieces of equipment to obtain the credited usage.

### BRIEF DESCRIPTION OF THE DRAWINGS

FIG. 1 is a flow chart of an embodiment of a method of providing equipment to a user;

FIG. 2 is a flow chart of an embodiment of a method of providing for changes to conditions identified with respect to providing equipment to a user;

FIG. 3 is a flow chart of an embodiment of a method of ending the provision of equipment to a user;

FIG. 4 is a plot of attributes determined during the course of providing equipment to a user; and

FIG. 5 is an embodiment of a system for implementing a method of providing equipment to a user.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

For convenience and explanatory purposes, the following terms and phrases, as used herein, shall have the meanings set forth below. Unless defined otherwise, all technical and scientific terms used herein have the same meaning as commonly understood to one of ordinary skill in the art to which this invention belongs. The word “usage” refers to the use of equipment in predetermined units of measure (e.g., test hour, wafer passes, devices, etc.). The phrase “unit of manufacturing depreciation” encompasses depreciating equipment based on the use of equipment as opposed to depreciating equipment based on the passage of time. A “pay-per-use” program encompasses a program or lease whereby a customer pays for a lease based on the use of the equipment under lease via a predetermined unit of measure. The phrase “minimum commitment” refers to the usage of equipment committed to by a user or customer for a predetermined period of time (.e.g., a month, quarter, etc.). The word “term” encompasses a predetermined number of periods of time, or time periods. The phrase “total commitment” refers to a total usage of the equipment committed to by the user or customer; a sum of the minimum commitments for the time periods of a term. The phrase “cumulative commitment”, or “cumulative minimum commitment”, refers to the sum of minimum commitments from program or lease commencement. The phrase “cumulative usage” refers to the sum of usage from program or lease commencement. The phrase “aggregated usage” refers to the sum of usage credited to the user from program or lease commencement.

The present disclosure is directed to methods and systems for converting the fixed cost of capital to a variable expense by, for example, structuring an operating lease based on a “unit of manufacturing” depreciation schedule rather than a time based depreciation, allowing charges to the customer on a “per unit” (per test hour, per component, per process, etc.) basis, and aligning expenses to production. As provided herein, the customer can commit to a minimum usage of the equipment per a specified time period, e.g., a month or quarter; however, the commitment can be a “cumulative” commitment, rather than based on each period, that can allow for a “pay-per-use” program. The customer can make payments only for the actual usage of the equipment during a current time period, provided that the aggregated usage for previous time periods plus the current time period is equal to or greater than the cumulative commitment.

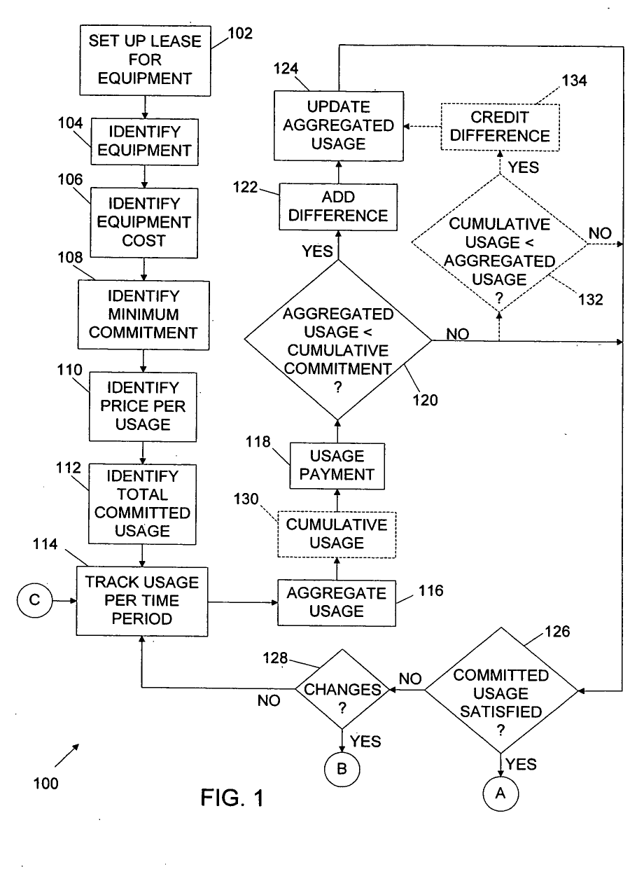

Referring now to FIG. 1, illustrated is a flow chart of an exemplary embodiment of a method 100 of providing equipment to a customer or other end user. As previously discussed, fixed capital equipment costs can adversely impact equipment users in a cyclical business environment. The methods and systems described herein can convert the fixed cost of capital to a variable expense, while providing the customer, or user, with enhanced financial and operating flexibility relative to direct purchase of equipment.

In the FIG. 1 embodiment, an operating lease for equipment can be established and or otherwise structured 102. In one example, the lease can be structured in accordance with FASB 13. Typical provisions of an FASB 13 operating lease can include: provisions relating to title of the equipment, e.g., the title not transferring to the lessee at the end of the lease and no “bargain purchase” option; the term or length of the lease, with the term being less than 75% of the useful life of the equipment; and provisions relating to the discounted present value of the committed payment stream, e.g., the value being less than 90% of the market value of the equipment at the time of sale.

Lease structures other than the FASB 13 operating lease structure and/or provisions other than those described above can be provided to accommodate the lessor and lessee for the particular transaction. This includes finance and capital leases that are carried on the balance sheet by the customer if the provisions and conditions of the lease would not otherwise align with FASB 13 to qualify as an operating lease. By structuring the transaction as an operating lease, the capital can be carried off-balance sheet, thus improving balance sheet ratios for the customer (asset turnover, return on assets, debt/equity, etc.). This can allow the customer more flexibility with its primary banks in regard to classic bank covenants and, particularly, capital equipment acquisitions. To define the lease, the equipment that is the subject of the lease can be identified, as at 104, together with the cost of the equipment, as at 106.

The lease can be based on a “unit of manufacturing” depreciation schedule rather than a time based depreciation. The “unit of manufacturing” depreciation schedule basis for the lease can allow charges to the customer on a “per unit of usage” (per test hour, per component, per process action, etc.) basis. Under GAAP, the customer can recognize the expense for reporting purposes on a similar per unit basis, and thus, expenses can be aligned with production, which can frequently be a proxy for revenue. If the underlying depreciation is based on time, under GAAP, the customer amortizes the total committed payments, regardless of when actually paid, on a level basis over the initial term of the lease.

With continued reference to FIG. 1, to establish the unit of manufacturing depreciation, the participants can identify a minimum usage per period, or minimum commitment 108, a price per unit of usage 10, and a total committed usage 112. A total committed usage can include the total amount of usage to which the customer commits over the course of the lease. The total committed usage, also referred to herein as committed usage, can be in terms of the units of usage for the equipment, e.g., a total of six thousand test hours where the unit of usage is a test hour. The price per unit of usage can be based on factors including acquisition costs of the equipment, length of the lease, committed usage, cost of money, profit margins, risks, remarketing costs, and other factors as appropriate to the transaction.

As an example, one or more services, such as maintenance charges, consumables contracts, front-end outside engineering services, on-going non-core engineering services, operators, etc., can be included in the variable price per unit. The price per unit of usage can change over the term of the lease depending on the amount of usage within a time period or on a cumulative usage amount. For example, the price per unit of usage can be specified at one level for usage within a time period below a certain threshold. If usage exceeds the threshold during a time period, the price per unit of usage can be adjusted up or down depending on the agreed upon structure of the lease. Similarly, the price per unit of usage can be adjusted up or down if cumulative usage exceeds a predetermined threshold. The adjustment can be applied to usage above the threshold, or to the total usage.

Per FASB 13, the discounted present value of the total committed usage of the equipment times the price per unit must be less than 90% of the original selling price of the equipment. For standard operating leases, the discounted present value is based on the customer's incremental borrowing rate for a loan with a similar total term, which can vary significantly from customer to customer. In a normal, competitive environment, the discounted present value of the payment stream, at the committed minimum for each period, can reflect the amount a lender is willing to provide, up-front, to own the equipment at the end of the lease. For the disclosed method, the total committed usage and/or price per unit of usage can be determined in the manner of an operating lease. For example, the total amount of payments over the term of the lease can be calculated such that the discounted present value, at the borrower's incremental borrowing rate, for the maximum term, with no residual value, can be less than 90% of the fair market value of the equipment at the time of purchase. By limiting the total amount of payments, the requirements of FASB 13 can set limits on the price per unit of usage and/or the committed usage. In one exemplary embodiment of the systems and methods disclosed herein, the price per unit of usage can be determined by dividing 90% of the fair market value of the equipment by the total committed usage.

Through discussions with the borrower, the practical number of units the borrower expects to be able to produce each time period and the maximum number of time periods to be incorporated into the pricing can be determined. The number of units of usage per time period can be based on the efficiency of the borrower's operation, the throughput of the equipment, and the expected demand for the borrower's product. The lease can be structured such that the borrower can “commit” to a usage per time period that is somewhat less than, e.g., 80-85% of, the expected usage per time period. This level of usage that the borrower commits to can be taken as the minimum commitment per time period.

In one exemplary embodiment, the total committed usage can be determined by summing the minimum commitments for each time period. In one exemplary embodiment of the methods and systems described herein, the price per unit of usage can be determined using one or more of the factors described previously, e.g., cost of the equipment, length of the lease, committed usage, cost of money, etc., and the total amount of payments can be calculated by summing the results of multiplying the price per unit of usage by the minimum commitment for each period. As described herein, the total amount of payments can be limited by the requirements of FASB 13. Adjustments to the price per unit of usage and/or the minimum commitments can be made so as to conform to the FASB 13 requirements.

In one embodiment, a minimum commitment can be multiplied by a maximum number of payment periods in the term of the lease to determine a total committed usage. As an example, for a lease with a maximum term of five years, with monthly payment periods (i.e., 60 payment periods) and a minimum commitment of 100 test hours per month, the total committed usage can be 60×100=6,000 test hours. Other means for determining a minimum commitment can also be used, provided that the sum of the minimum commitments total to the committed usage. For example, a minimum commitment at the start of the lease can be less than that near the end of the lease to provide for ramping up production.

The usage can be tracked 114 over a time period and aggregated 116 with the previous aggregated usage. The payment for the period can be at least equal to the usage for the period times the price per unit of usage 118. If the aggregated usage is less than the cumulative minimum commitment 120, the payment for the time period can include a payment for the difference between the cumulative minimum commitment and the aggregated usage multiplied by the price per unit of usage 122. Additionally, the aggregated usage can be updated to include the difference 124. When the aggregated usage is less than the cumulative minimum commitment the difference is positive and is added to the aggregated usage to obtain the updated aggregated usage.

The cumulative minimum commitment, also referred to herein as the cumulative commitment, can be taken as the sum of the minimum commitments up to and including the payment period for which the payment is being calculated. For this example of a linear minimum commitment as described herein, the cumulative commitment for the eighth payment period can be calculated as 8×100=800 test hours. For an exemplary usage for the eighth payment period of 90 test hours, an aggregated usage of 850 test hours, previous payments totaling $760, at a unit pricing of $1.00 per test hour, and committed usage of 6,000 test hours, the payment 118 can be at least equal to the usage for the period multiplied by the price per unit of usage, 90×$1.00=$90.00. For this example, the aggregated usage is greater than the cumulative commitment (i.e., 850>800, as determined at 120) and no additional payment is required.

Considering the previous example, but with a modified usage for the eighth payment period of 30 test hours. The payment 118 can be at least equal to the usage for the period multiplied by the price per unit of usage, 30×$1.00=$30.00. The aggregated usage for this modified usage is now (850−90)+30=790 hours, and is less than the cumulative minimum commitment (i.e., 790<800, as determined at 120). The payment can include 122 a payment for the difference between the cumulative commitment and the aggregated usage multiplied by the price per unit of usage (800−790)×$1.00=$10.00. The total payment for the time period is the usage payment plus the difference payment $30.00+$10.00=$40.00, and the aggregated usage can be set 124 to the cumulative commitment of 800.

By updating the aggregated usage to include the difference 124, the lessee can effectively be credited for the amount of usage paid for, whether or not the equipment was physically used. Following payment, if the committed usage has been satisfied, or completed 126, systems and methods according to FIG. 1 can proceed to complete the lease, as indicated at “A”. If the committed usage has not been satisfied, and no changes to the lease are requested, as determined at 128, the exemplary systems and methods such as those according to FIG. 1 can return to tracking usage 114 for the next payment period.

Optionally and as shown in phantom in FIG. 1, the usage for the period can be added to previous cumulative usage 130. If the cumulative usage is less than the aggregated usage 132, a credit for the lesser of the difference between the aggregated usage and the cumulative usage or the difference between the aggregated usage and the cumulative commitment can be applied to the payment by multiplying the lesser difference by the price per unit of usage 134. As previously, the aggregated usage can be updated to include the difference 124. When the cumulative usage is less than the aggregated usage 132, the difference is negative and is subtracted from the aggregated usage to obtain the updated aggregated usage. When the cumulative usage is at least equal to the aggregated usage 132, neither a credit nor an additional payment is provided and the aggregated usage is not updated.

Consider the above example, but with a usage for the eighth payment period of 110 test hours, a cumulative usage of 780 test hours (optionally tracked at 130) and an aggregated usage of 810. The aggregated usage is greater than the cumulative commitment (810>800), as determined at 120, and the cumulative usage is less than the aggregated usage (780<810), as optionally determined at 132. The difference between the aggregated usage and the cumulative usage is 810−780=30. The difference between the aggregated usage and the cumulative commitment is 810−800=10. Optionally, the lesser credit (i.e., 10) is applied 134 to the usage payment $110.00−(10*$1.00)=$100.00. The aggregated usage is updated 124 to include the difference 810−10=800. Without the optional actions described herein, the usage payment and the aggregated usage would not be credited and updated, respectively.

By structuring the lease as above, the lessee, or customer can be committed to a minimum usage of the equipment per a specified payment period; however, the commitment is a “cumulative” commitment rather than based on a minimum usage per each period. This allows for a “pay-per-use” program such that if the customer has less usage than a minimum commitment during a payment period, the payment would reflect the actual usage if the aggregated usage was equal to or greater than the cumulative commitment, even if the usage was zero. Consider, for example, a minimum commitment of 100 test hours per period, a usage of 80 test hours for the eighth payment period, and an aggregate prior usage equal to 850 test hours. Based on this example, the payment for the eighth period would be based on the usage of 80 test hours, and not on the minimum commitment of 100 hours per payment period.

For the lessee, the disclosed method of structuring the lease can convert the fixed cost of capital to variable cost. The cost of the equipment to the lessee will vary according to the usage of the equipment, and thus, the disclosed methods may stabilize margins in uncertain cyclical environments, and may improve cash flow during periods of slower activity. Improving cash flow during cyclical downturns can alleviate pressure on the lessee, or customer, to reduce personnel and/or to cut worthwhile research programs.

With variable capital costs, a customer may be more likely to buy equipment closer to cyclical peaks knowing that usage, and thus costs, can be reduced once cresting the peak. With fixed costs, capital budgets can frequently be frozen as customers approach what they believe to be cyclical peaks, since the customer can be unwilling to sustain ongoing depreciation on underutilized equipment. The ability to continue purchasing equipment at peak periods can allow lessees to better serve their customers by not increasing lead times. Further, this ability can allow lessees to potentially gain share of market as competitors may not increase their own productive capacity.

As noted, if the usage during a payment period is insufficient to meet the cumulative minimum commitment, the usage payment is increased and the aggregated usage is updated based on the difference between the cumulative minimum commitment and the aggregated usage. The payment and associated usage can be credited towards the expected payments associated with the minimum commitment and towards the cumulative minimum commitment. The customer's payments can thus remain current relative to the minimum expected payments. This can accomplish at least two positive benefits. First, if the customer is below the committed usage at the end of the lease term, there are no understated expenses over the life of the lease and there is no accumulated deficit payment that could require a large cash outflow at the end of the term. Additionally, by having a known minimum payment stream, the lease paper can be financed with third party lenders based on the minimum committed usage and payment stream. By not requiring a lender to assume the risk of variable payments, the financing of the lease can attract more prospective lenders at a lower cost than would otherwise be the case if the lender had to absorb an unknown payment stream.

Generally, in structuring the lease, a minimum commitment can be identified such that customer's actual usage of the equipment can typically exceed the minimum commitment, and the payments can exceed the corresponding minimum payments. The “excess” usage/payments over the cumulative minimum commitment can provide for improved flexibility of the lease, as described herein. For example, if the aggregate excess is at least as large as the minimum commitment, the lessee can omit a payment if there is no usage during a payment period.

In one embodiment, the lease can include one or more pieces of equipment. Usage can be tracked individually for each piece of equipment. In one exemplary embodiment, equipment usage can be pooled and/or grouped for purposes of meeting the minimum commitment. The customer can thus choose which piece of equipment to utilize without regard for the individual minimum commitment for any one piece of equipment, thus providing additional operating flexibility that might otherwise be lost.

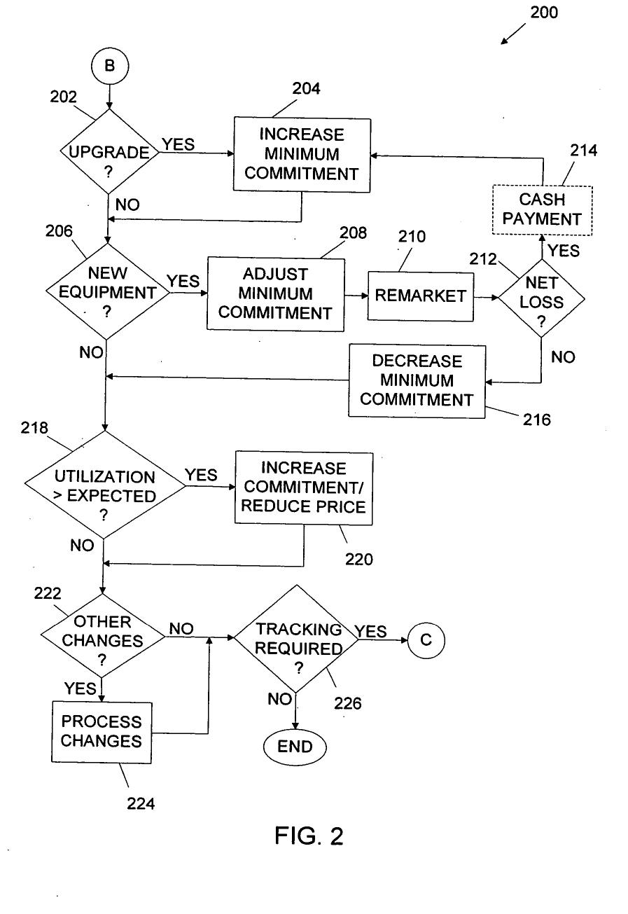

With continued reference to FIG. 1, if changes effecting the minimum commitment are requested during the term of the lease 134, as indicated at “B”, the changes can be accommodated, where one embodiment of such accommodation is illustrated by FIG. 2. Such changes can include equipment upgrades, substituting new equipment for the original equipment, and greater than expected usage of the equipment.

The example flow chart of FIG. 2 therefore illustrates one embodiment of a method 200 for accommodating changes to the lease structure. The customer can upgrade equipment 202 during the life of the lease, e.g., by installing software updates, new processing tools, and/or other equipment upgrades. Rather than having to pay cash for upgrades, the customer can increase the minimum commitment 204. In many cases, depending on quantity, this can be done with no change in price per unit of usage. The customer can thus extend the useful life of the equipment without incurring capital expenses and without incurring increases in price per unit of usage. Once the new minimum commitment is established, additional changes can be processed.

The customer can also request substituting existing equipment with new equipment 206. Generally, the minimum commitment can be adjusted 208 to reflect the value of the new equipment with respect to the existing equipment. The existing equipment can be remarketed 210, and the provider of the lease can assume the responsibility of remarketing the old equipment, while the customer assumes the risk of the net realized value of the sale. If the net realized value is below the provider's required value for the equipment 212, the customer can be responsible for the difference. If the net realized value is greater than the required value of the equipment, the customer and/or the lessor can be credited with all, or part of, the benefit. The customer can remain responsible for the minimum commitment during the remarketing period.

Since the customer assumes the market risk, the lease need not include a risk premium. The equipment can be sold with little or no financial penalty to the customer, whereas, with current structuring, equipment leases generally are non-cancelable and can carry significant premiums or penalties for early termination. Additionally, third party lenders, assured of getting their required value, without risk, and assured of the on-going amortization of their financing during the remarketing period, can be more willing to provide financing under the lease structure described herein than under other lease structures, providing more prospective lenders and lower prospective cost to the customer or lessee. The customer can therefore also have greater flexibility in upgrading and/or trading equipment than otherwise would be the case.

If there is a deficit on the net sale, the cost of such can be incorporated into the program and amortized over the remaining usage commitment by increasing the minimum commitment 204. Additionally and/or optionally, the customer can make a cash payment for all or a portion of the difference 214. If there is a gain, this can be used to acquire the new equipment with a smaller net new minimum commitment, as indicated at 216, than would otherwise be required. This again provides the customer flexibility in better matching technology requirements to needs while diminishing concerns about unplanned financial gains or losses.

If the equipment is being utilized ahead of expectations 218, the customer can increase the minimum commitment and effectively reduce the price per unit of usage 220. Accordingly, the customer can effectively decrease expenses. This can be particularly attractive when the average selling price of the customer's final product declines over time. This can assist in stabilizing margins and can better reflect gross margins associated with the use of equipment, rather than overstating margins early in the equipment's life and understating it later. Additionally, the ability to lower costs may allow the customer to lower selling prices, and may allow the customer to gain market share against competitors that cannot afford to lower prices. Those of skill in the art can recognize that other changes can be contemplated and can be accommodated, as indicated at 222 and 224. Methods and systems according to FIG. 2 can, as provided herein, be incorporated with methods and systems according to FIG. 1, shown via a return to the FIG. 1 method 100, indicated at “C” in FIGS. 1 and 2, when the changes have been processed and one or more changes require additional tracking of usage 226.

In one embodiment, the lease structure can include a “just-in-time” front-end, with such name provided for convenience and explanatory purposes. This just-in-time front-end can include one or more payment periods during which the minimum commitment can be substantially reduced and/or eliminated. By using the just-in-time front end, a customer can undertake program development on the equipment with prospectively negligible expense and/or can have the equipment in a production ready mode with no immediately recognized expense until demand requires its usage. This can effectively provide the customer with “just-in-time” capacity. In traditional lease structures under GAAP, with equipment depreciation over time, a depreciation expense can be incurred even though the equipment is idle (e.g., during system integration, installation, etc.). Having equipment in-place, ready for production without incurring the depreciation expense can improve the customers' time to market, production ramp, market share, and return on investment.

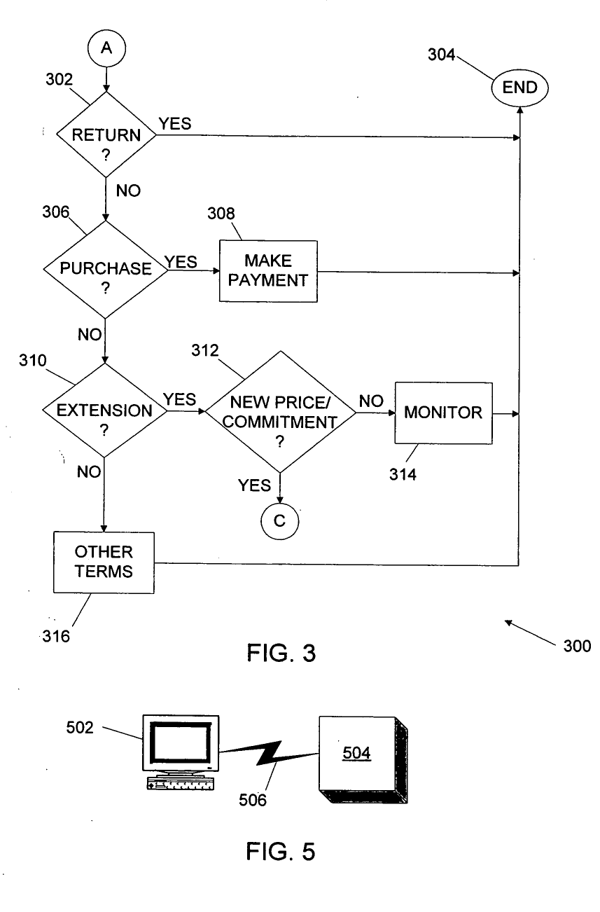

Returning to FIG. 1, once the total committed usage has been satisfied 126, the lease can be completed, as indicated at “A”. FIG. 3 illustrates one embodiment of a method 300 for completing the lease that can accommodate a number of options for ending the lease. For example, the equipment can be returned 302 without further obligation, thus ending the lease 304. The equipment can be purchased 306 by the customer making a payment and/or payments 308 for the fair market value, or other agreed upon value, of the equipment. The lease can be extended 310 such that the customer can continue using the equipment. The provisions of the extension can be predetermined and/or agreed upon at the time of the extension. When the provisions of the extension include an agreed-upon price per unit of usage and continued commitment 312, a return to a method 100 according to FIG. 1 to track usage, as indicated at “C” in FIGS. 1 and 3, can be performed. Otherwise, the equipment can be monitored during an extension 314 until the provisions are fulfilled 304. Other end of lease provisions can be contemplated and accommodated as indicated at 316. As an example, the total actual usage can exceed the total committed usage prior to the completion of the lease term. In such case, the lessee can be charged a predetermined price for such usage, or can continue using the equipment at no additional cost. The predetermined price can be the same price per unit as was previously used, or a lesser price per unit. Though unlikely, in some instances, the predetermined price per unit of usage can be greater for usage above the total committed usage.

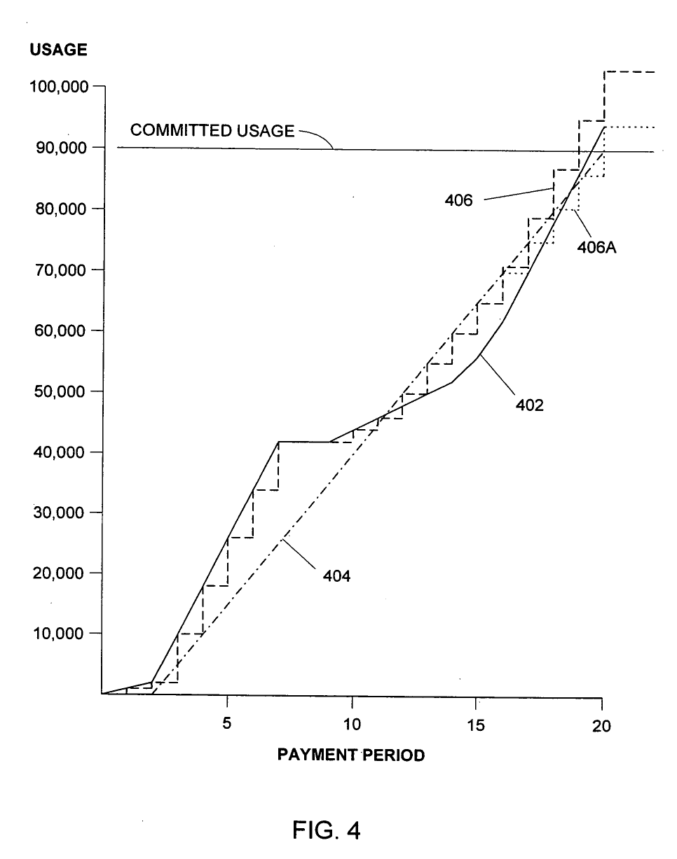

Referring now to FIG. 4, illustrated is a plot or graph 400 of cumulative usage (solid line 402) and cumulative minimum commitment (dash-dot line 404) for an exemplary lease having twenty payment periods. For the exemplary lease shown in FIG. 4, the committed usage is 90,000 test hours and the cumulative minimum commitment 404 is linear, i.e., the minimum commitment per payment period is constant. The exemplary lease of FIG. 4 includes a “just-in-time” front-end of two payment periods, and thus, the cumulative minimum commitment 404 begins after payment period two and extends linearly to the committed usage of 90,000 test hours at payment period twenty, with a minimum commitment of 5,000 test hours per payment period.

The cumulative usage 402 is plotted based on the following actual usages per payment period shown in Table 1. The payments and aggregated usage shown in Table 1 are determined as described for a method 100 according to FIG. 1, and as provided herein, with the payments based on a price per unit of usage of $1.00 for simplicity. The aggregated usage shown for a period is the updated aggregated usage. A plot of the aggregated payments is indicated as dashed line 406 in FIG. 4. Payments and aggregated payments for the optional actions 126, 132, and 134 described with respect to FIG. 1 are shown in parentheses in Table 1 and plotted as dotted line 406A in FIG. 4, when they differ from payments determined as described above.

TABLE 1

| | | | | | | Updated |
|---|---|---|---|---|---|---|
| | | | Cumulative | | Aggregated | Aggregated |
| | Usage | Cumulative Usage | Commitment | Payment | Usage | Usage |
| 1 | 1,000 | 1,000 | 0 | $1,000 | 1,000 | 1,000 |
| 2 | 1,000 | 2,000 | 0 | $1,000 | 2,000 | 2,000 |
| 3 | 8,000 | 10,000 | 5,000 | $8,000 | 10,000 | 10,000 |
| 4 | 8,000 | 18,000 | 10,000 | $8,000 | 18,000 | 18,000 |
| 5 | 8,000 | 26,000 | 15,000 | $8,000 | 26,000 | 26,000 |
| 6 | 8,000 | 34,000 | 20,000 | $8,000 | 34,000 | 34,000 |
| 7 | 8,000 | 42,000 | 25,000 | $8,000 | 42,000 | 42,000 |
| 8 | 0 | 42,000 | 30,000 | 0 | 42,000 | 42,000 |
| 9 | 0 | 42,000 | 35,000 | 0 | 42,000 | 42,000 |
| 10 | 2,000 | 44,000 | 40,000 | $2,000 | 44,000 | 44,000 |
| 11 | 2,000 | 46,000 | 45,000 | $2,000 | 46,000 | 46,000 |
| 12 | 2,000 | 48,000 | 50,000 | $4,000 | 48,000 | 50,000 |
| 13 | 2,000 | 50,000 | 55,000 | $5,000 | 52,000 | 55,000 |
| 14 | 2,000 | 52,000 | 60,000 | $5,000 | 57,000 | 60,000 |
| 15 | 4,000 | 56,000 | 65,000 | $5,000 | 64,000 | 65,000 |
| 16 | 6,000 | 62,000 | 70,000 | $6,000 | 71,000 | 71,000 |
| | | | | ($5,000) | (71,000) | (70,000) |
| 17 | 8,000 | 70,000 | 75,000 | $8,000 | 79,000 | 79,000 |
| | | | | ($5,000) | (78,000) | (75,000) |
| 18 | 8,000 | 78,000 | 80,000 | $8,000 | 87,000 | 87,000 |
| | | | | ($5,000) | (83,000) | (80,000) |
| 19 | 8,000 | 86,000 | 85,000 | $8,000 | 95,000 | 95,000 |
| | | | | ($6,000) | (88,000) | (86,000) |
| 20 | 8,000 | 94,000 | 90,000 | $8,000 | 103,000 | 103,000 |
| | | | | | (94,000) | (94,000) |

Table 1 and FIG. 4 illustrate that the payments for periods up to and including period 11 are based on the usage for the period, since the aggregated usage is at least equal to the cumulative minimum commitment for those periods. For periods 12 through 15, the aggregated usage is less than the cumulative minimum commitment. Thus, the difference between the cumulative commitment and the aggregated usage is added to the usage payment and the aggregated usage is updated to reflect the difference. For periods 16 through 20, the aggregated usage is at least equal to the cumulative minimum commitment, and the usage payment is made. At period 19, the aggregated usage exceeds the total commitment and the lease can end, as described with respect to FIGS. 1 and 3. For the exemplary lease of Table 1, an extension 310 is provided at the same price per unit of usage. Thus, usage and payments continue into period 20. Optionally, the lessee can end usage upon reaching the 90,000 committed usage payment level or can continue usage without further payments beyond the 90,000 committed usage payment level.

For the optionally determined payments, payments 1 through 15 are the same as previously described. For periods 16 through 20, the aggregated usage is at least equal to the cumulative minimum commitment, and the usage payment is made. For payments 16 through 20, the cumulative usage is less than the aggregated usage, and a credit is applied to the payment. The credit is equal to the lesser of the difference between the aggregated usage and the cumulative usage or the difference between the aggregated usage and the cumulative commitment. The aggregated usage is updated to reflect the difference. Considering the exemplary period 18, the usage payment is $8,000, and the aggregated usage is greater than the cumulative commitment (83,000>80,000). The cumulative usage is less than the aggregated usage (78,000<83,000) so a credit is provided. The difference between the aggregated usage and the cumulative usage (83,000−78,000=5,000) is greater than the difference between the aggregated usage and the cumulative commitment (83,000−80,000=3,000), so a credit of $3,000 is provided and the aggregated usage is updated by the difference (83,000−3,000=80,000).

What has thus been described are methods and systems for converting the fixed cost of capital to a variable expense include structuring an operating lease based on a “unit of manufacturing” depreciation schedule rather than a time based depreciation, allowing charges to the customer on a “per unit” (per test hour, per component, per process, etc.) basis and aligning expenses to production. The customer can commit to a minimum usage of the equipment per a specified time period; however, the commitment can be a “cumulative” commitment, rather than based on each period, that can allow for a “pay-per-use” program. The customer can make payments only for the actual usage of the equipment during a current time period, provided that the aggregated usage for previous time periods plus the current time period is equal to or greater than the cumulative commitment.

The methods described herein can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. For example, FIG. 5 illustrates one embodiment of a system 500 having a processor 502 connected to equipment 504 via a network 506. Equipment 504 can include one or more processors for controlling equipment 504, and/or processor 502 can provide a level of control for equipment 504, or control can be provided by a separate processor (not shown). The configuration of components illustrated in FIG. 5 is not exhaustive and is provided for illustration and not limitation. For example, the reporting of usage, etc., can be done using electronic devices and/or wired and/or wireless communications, although other methods of reporting (telephone, manual, combinations thereof) can be used.

Processor 502 can access one or more input devices to obtain input data, e.g., data pertaining to the lease provisions, and can access one or more output devices to communicate output data, e.g., usage. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where network 506 can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to data can be understood to include databases and/or one or more memory associations, where such references can include commercially available database products (e.g., SQL, Informix, Oracle) and also proprietary databases, and may also include other structures for associating memory such as links, queues, graphs, trees, with such structures provided for illustration and not limitation.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

1. A method of payment for equipment usage, the method comprising:
establishing a minimum commitment for equipment usage per time period; and
exchanging payments for the equipment usage per time period based on a greater one of aggregated usage and cumulative minimum commitments.

2. The method of claim 1, wherein exchanging payments comprises:
multiplying said equipment usage by a price per unit of usage to obtain a usage payment;
determining a first difference between the cumulative minimum commitments and the aggregated usage when the aggregated usage is less than the cumulative minimum commitments;
adding to the usage payment an amount determined by multiplying said first difference by the price per unit of usage; and
updating the aggregated usage to include the first difference.

3. The method of claim 2, wherein establishing the minimum commitment comprises:
identifying costs for the equipment; and
identifying the price per unit of usage based on the costs of the equipment.

4. The method of claim 3, wherein the costs are based on at least one of an acquisition cost of the equipment, services to be provided, and supplies to be provided.

5. The method of claim 4, wherein the costs are further based on at least one of an expected value of the equipment after a predetermined number of time periods, remarketing costs, a time value of money, profit margins, and risk of loss.

6. The method of claim 2, wherein exchanging payments comprises:
determining a second difference between the aggregated usage and a cumulative usage when the aggregated usage is at least equal to the cumulative minimum commitment and the cumulative usage is less than the aggregated usage;
subtracting from the usage payment an amount determined by multiplying a lesser one of the first difference and the second difference by the price per unit of usage; and
updating the aggregated usage by subtracting the lesser one.

7. The method of claim 1, further comprising:
identifying a number of time periods as a term for the usage of the equipment; and
identifying a total commitment for the term of usage as a sum of the minimum commitments for the time periods of the term, wherein exchanging payments is limited by the total commitment.

8. The method of claim 7, further comprising exchanging a payment to purchase the equipment when a total of payments exceeds the total commitment multiplied by a price per unit of usage.

9. The method of claim 7, further comprising:
determining a price per unit of usage based on continued usage of the equipment beyond the total commitment;
increasing the total commitment when the aggregated usage exceeds the total commitment; and
exchanging payments for continued usage based on the continued usage multiplied by the price per unit of usage.

10. The method of claim 1, further comprising setting the minimum commitment for at least one time period at a start of the equipment usage to a lesser amount than the minimum commitment for other time periods.

11. The method of claim 1, further comprising increasing the minimum commitment to obtain upgrades for the equipment.

12. The method of claim 1, further comprising:
remarketing the equipment to obtain new equipment; and
changing the minimum commitment based on a difference between a market value and a value realized by the remarketing.

13. The method of claim 12, wherein changing the minimum commitment comprises exchanging a payment based on the difference.

14. The method of claim 1, wherein the equipment comprises multiple pieces of equipment, the method further comprising combining usage for the multiple pieces of equipment to obtain the equipment usage per time period.

15. A method of payment for equipment usage, the method comprising:
establishing a minimum commitment for equipment usage per time period based on multiplying a minimum number of units of usage per time period by a price per unit of usage;
multiplying an aggregated usage by the price per unit of usage to obtain a first payment;
exchanging payments for the equipment usage per time period based on subtracting a total of previous payments from a greater one of the first payment and cumulative minimum commitments; and
updating the aggregated usage to reflect the cumulative minimum commitments when the cumulative minimum commitments exceed the first payment.

16. The method of claim 15, wherein exchanging payments further comprises:
determining a first difference based on subtracting the cumulative minimum commitments from the first payment when the first payment is greater than the cumulative minimum commitments;
determining a second difference based on multiplying a result of subtracting cumulative usage from the aggregated usage by the price per unit of usage when the cumulative usage is less than the aggregated usage;
subtracting from the first payment an amount equal to multiplying a lesser one of the first difference and the second difference by the price per unit of usage; and
updating the aggregated usage by subtracting the lesser one from the aggregated usage.

17. A computer program tangibly stored on a computer-readable medium and operable to cause a computer to enable structuring a requirements contract for equipment usage, the computer program comprising instructions to:
establish a price per unit of usage;
establish a minimum number of units of usage per time period;
track usage of the equipment per time period;
obtain payments per time period based on multiplying a credited number of units of usage by a price per unit of usage and subtracting a total of previous payments, wherein cumulative payments for a number of time periods are at least equal to an amount determined by multiplying a total of the minimum number of units of usage over the number of time periods by the price per unit of usage; and
update the credited usage to reflect the cumulative payments when the total of the minimum number of units of usage over the number of time periods exceeds the credited usage.

18. The computer program of claim 17, further comprising instructions to:
subtract a credit from the payments for the equipment usage for a time period when the credited usage is greater than the total of the minimum number of units through the time period, and greater than cumulative usage through the time period; and
update the credited usage to reflect the credit.

19. The computer program of claim 18, wherein the instructions to subtract the credit further comprise instructions to:
determine a first difference between the credited usage and the cumulative usage;
determine a second difference between the credited usage and the total of the minimum number of units; and
determine the credit by multiplying the price per unit of usage by a lesser one of the first difference and the second difference.

20. The computer program of claim 17, wherein the instructions to establish a price per unit of usage further comprise instructions to establish the costs based on at least one of an acquisition cost of the equipment, services to be provided, and supplies to be provided.

21. The computer program of claim 20, wherein the instructions to establish a price per unit of usage further comprise instructions to establish the costs based on at least one of an expected value of the equipment after a predetermined number of time periods, expected remarketing costs, a time value of money, profit margins, and risk of loss.

22. The computer program of claim 17, further comprising instructions to:
identify a number of time periods as a term for the usage of the equipment;
identify a total commitment for the term of usage as a sum of the minimum number of units of usage for the time periods of the term; and
limit the payments obtained to the total commitment multiplied by the price per unit of usage.

23. The computer program of claim 22, further comprising instructions to obtain a payment to purchase the equipment when a total of payments exceeds the total commitment multiplied by the price per unit of usage.

24. The computer program of claim 22, further comprising instructions to:
determine a price per unit of usage based on continued usage of the equipment beyond the total commitment; and
obtain payments for continued usage based on the continued usage multiplied by the price per unit of usage.

25. The computer program of claim 17, further comprising instructions to set the minimum number of units of usage for at least one time period at a start of the equipment usage to a lesser amount than the minimum number of units of usage for other time periods.

26. The computer program of claim 17, further comprising instructions to:
increase the minimum number of units of usage; and
obtain upgrades for the equipment based on the increase.

27. The computer program of claim 17, further comprising instructions to:
remarket the equipment to obtain new equipment; and
adjust the payments based on a difference between a market value and a value realized by the remarket.

28. The computer program of claim 17, wherein the equipment comprises multiple pieces of equipment and wherein the instructions to track usage further comprise instructions to combine usage for the multiple pieces of equipment.

29. A method of leasing equipment, comprising:
establishing a price per unit of equipment usage;
establishing a minimum number of units of equipment usage per time period; and
exchanging payments per time period based on multiplying a credited number of units of usage by the price per unit of equipment usage and subtracting a total of previous payments, wherein cumulative payments for a number of time periods are at least equal to an amount determined by multiplying a total of the minimum number of units of equipment usage over the number of time periods by the price per unit of equipment usage; and
updating the credited usage to reflect the cumulative payments when the total of the minimum number of units of equipment usage over the number of time periods exceeds the credited usage.

30. A method of leasing equipment for a specified number of time periods, comprising:
providing the equipment for use;
identifying a value of the equipment;
identifying a price per unit of usage based on the value of the equipment;
establishing a cumulative minimum number of units of usage per each of the time periods;
tracking usage of the equipment for each time period and adding the usage to previous usage to obtain total usage;
obtaining payments for usage of the equipment per time period based on multiplying a greater one of the total usage and the cumulative minimum number by the price per unit of usage and subtracting a total of previous payments; and
updating the total usage to reflect the cumulative minimum number when the cumulative minimum number is greater than the total usage.

31. A method of depreciating equipment, comprising:
establishing a minimum commitment for usage of the equipment per time period;
establishing a price per unit of usage;
determining a greater one of cumulative usage and cumulative minimum commitment for a time period;
multiplying the greater one by the price per unit of usage and subtracting a total of previous depreciation to obtain a depreciation expense for the time period;
incurring the depreciation expense; and
updating the cumulative usage to reflect the cumulative minimum commitment when the cumulative minimum commitment is greater than the cumulative usage.

32. A computer program tangibly stored on a computer-readable medium and operable to cause a computer to enable depreciation of equipment, the computer program comprising instructions to:
establish a minimum commitment for usage of the equipment per time period;
establish a price per unit of usage;
determine a greater one of a credited usage and cumulative minimum commitment for a time period;
multiply the greater one by the price per unit of usage and subtract a total of previous depreciation to obtain a depreciation expense for the time period;
incur the depreciation expense; and
update the credited usage to reflect the cumulative minimum commitment when the cumulative minimum commitment is greater than the credited usage.

33. The computer program of claim 32, wherein the instructions to establish a price per unit of usage comprise instructions to adjust the price per unit of usage when a predetermined threshold amount of usage is exceeded.

34. The computer program of claim 32, wherein the instructions to establish a price per unit of usage comprise instructions to:
identify costs of the equipment; and
determine the price per unit of usage based on the costs of the equipment.

35. The computer program of claim 34, wherein the instructions to identify costs of the equipment comprise instructions to determine the costs based on at least one of an acquisition cost of the equipment, services to be provided, and supplies to be provided.

36. The computer program of claim 35, wherein the instructions to identify costs of the equipment further comprise instructions to determine costs based on at least one of an expected value of the equipment after a predetermined number of time periods, remarketing costs, a time value of money, profit margins, and risk of loss.

37. The computer program of claim 32, further comprising instructions to:
identify a number of time periods as a term for the usage of the equipment; and
limit the depreciation expense to a sum of the minimum commitments for the time periods of the term multiplied by the price per unit of usage.

38. The computer program of claim 37, further comprising instructions to purchase the equipment when the credited usage exceeds the sum of the minimum commitments.

39. The computer program of claim 37, further comprising instructions to:
determine a price per unit of usage based on continued usage of the equipment beyond the sum of the minimum commitments; and
incur additional depreciation expense for the continued usage based on the continued usage multiplied by the price per unit of usage.

40. The computer program of claim 32, further comprising instructions to set the minimum commitment for at least one time period at a start of the equipment usage to a lesser amount than the minimum commitment for other time periods.

41. The computer program of claim 32, further comprising instructions to:
increase the minimum number of units of usage; and
obtain upgrades for the equipment based on the increase.

42. The computer program of claim 32, further comprising instructions to:
remarket the equipment to obtain new equipment; and
adjust the depreciation expense based on a difference between a market value and a value realized by the remarket.

43. The computer program of claim 32, wherein the instructions to incur the depreciation expense further comprise instructions to:
subtract a credit from the depreciation expense for a time period when the credited usage is greater than the total of the minimum number of units through the time period, and greater than cumulative usage through the time period; and
update the credited usage to reflect the credit.

44. The computer program of claim 32, wherein the equipment comprises multiple pieces of equipment, the computer program further comprising instructions to:
track usage per time period for each one of the multiple pieces of equipment; and
combine the usages per time period for the multiple pieces of equipment to obtain the credited usage.
